(19) United States
(12) Patent Application Publication
(10) Pub. No.: US 2022/0038335 A1
(43) Pub. Date: Feb. 3, 2022

(54) AUTOMATIC ORCHESTRATION OF IOT DEVICE DATA MANAGEMENT PIPELINE OPERATIONS

(71) Applicant: Cisco Technology, Inc., San Jose, CA (US)

(72) Inventors: Robert E. Barton, Richmond (CA); Stephan Edward Friedl, Frederick, CO (US); Anoop Mohan, San Ramon, CA (US); Norbert Heusser, Bornheim (DE); Yogesh Kumar Soni, Fremont, CA (US); Daniel Eckstein, Bonn (DE); Jerome Henry, Pittsboro, NC (US); Vinay Saini, Bangalore (IN)

(21) Appl. No.: 16/943,031

(22) Filed: Jul. 30, 2020

(51) Int. Cl. H04L 12/24; H04L 29/08; G06F 16/955; G06F 16/25

(52) U.S. Cl. CPC H04L 41/0806; G06F 16/254; G06F 16/955; H04L 67/2809

(57) ABSTRACT

In one embodiment, a supervisory device that supervises an edge device at an edge of a network receives a uniform resource identifier specified by a node in the network. The supervisory device retrieves information regarding the node located at the uniform resource identifier. The supervisory device generates, based on the information regarding the node, a data pipeline configuration for the edge device. The supervisory device sends the data pipeline configuration to the edge device. The data pipeline configuration causes the edge device to extract data from traffic sent by the node in the network and specifies one or more cloud-hosted applications to which the data should be sent.

### TECHNICAL FIELD

The present disclosure relates generally to computer networks, and, more particularly, to automatic orchestration of Internet of Things (IoT) device data management pipeline operations.

### BACKGROUND

The Internet of Things, or “IoT” for short, represents an evolution of computer networks that seeks to connect many everyday objects to the Internet. Notably, there has been a recent proliferation of ‘smart’ devices that are Internet-capable such as thermostats, lighting, televisions, cameras, and the like. In many implementations, these devices may also communicate with one another. For example, an IoT motion sensor may communicate with one or more smart lightbulbs, to actuate the lighting in a room when a person enters the room. Vehicles are another class of ‘things’ that are being connected via the IoT for purposes of sharing sensor data, implementing self-driving capabilities, monitoring, and the like.

As the IoT evolves, the variety of IoT devices will continue to grow, as well as the number of applications associated with the IoT devices. For instance, multiple cloud-based, business intelligence (BI) applications may take as input measurements captured by a particular IoT sensor. To this end, data pipelines are often constructed from the edge device(s) of the IoT network to the destination cloud provider.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrate an example network;

FIG. 2 illustrates an example network device/node;

FIG. 3 illustrates an example network architecture for edge to multi-cloud processing and governance;

FIGS. 4A-4B illustrate examples of data processing by an edge device in a network;

FIG. 5 illustrates an example of the application of a script to data extracted from traffic in a network;

FIGS. 6A-6E illustrates an example of the automatic orchestration of device data management pipeline operations; and

FIG. 7 illustrates an example simplified procedure for the configuration of a data management pipeline for an edge device.

### DESCRIPTION OF EXAMPLE EMBODIMENTS

### Overview

According to one or more embodiments of the disclosure, a supervisory device that supervises an edge device at an edge of a network receives a uniform resource identifier specified by a node in the network. The supervisory device retrieves information regarding the node located at the uniform resource identifier. The supervisory device generates, based on the information regarding the node, a data pipeline configuration for the edge device. The supervisory device sends the data pipeline configuration to the edge device. The data pipeline configuration causes the edge device to extract data from traffic sent by the node in the network and specifies one or more cloud-hosted applications to which the data should be sent

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, or Powerline Communications (PLC), and others. Other types of networks, such as field area networks (FANs), neighborhood area networks (NANs), personal area networks (PANs), etc. may also make up the components of any given computer network.

In various embodiments, computer networks may include an Internet of Things network. Loosely, the term “Internet of Things” or “IoT” (or “Internet of Everything” or “IoE”) refers to uniquely identifiable objects (things) and their virtual representations in a network-based architecture. In particular, the IoT involves the ability to connect more than just computers and communications devices, but rather the ability to connect “objects” in general, such as lights, appliances, vehicles, heating, ventilating, and air-conditioning (HVAC), windows and window shades and blinds, doors, locks, etc. The “Internet of Things” thus generally refers to the interconnection of objects (e.g., smart objects), such as sensors and actuators, over a computer network (e.g., via IP), which may be the public Internet or a private network.

Often, IoT networks operate within a shared-media mesh networks, such as wireless or PLC networks, etc., and are often on what is referred to as Low-Power and Lossy Networks (LLNs), which are a class of network in which both the routers and their interconnect are constrained. That is, LLN devices/routers typically operate with constraints, e.g., processing power, memory, and/or energy (battery), and their interconnects are characterized by, illustratively, high loss rates, low data rates, and/or instability. IoT networks are comprised of anything from a few dozen to thousands or even millions of devices, and support point-to-point traffic (between devices inside the network), point-to-multipoint traffic (from a central control point such as a root node to a subset of devices inside the network), and multipoint-to-point traffic (from devices inside the network towards a central control point).

Edge computing, also sometimes referred to as “fog” computing, is a distributed approach of cloud implementation that acts as an intermediate layer from local networks (e.g., IoT networks) to the cloud (e.g., centralized and/or shared resources, as will be understood by those skilled in the art). That is, generally, edge computing entails using devices at the network edge to provide application services, including computation, networking, and storage, to the local nodes in the network, in contrast to cloud-based approaches that rely on remote data centers/cloud environments for the services. To this end, an edge node is a functional node that is deployed close to IoT endpoints to provide computing, storage, and networking resources and services. Multiple edge nodes organized or configured together form an edge compute system, to implement a particular solution. Edge nodes and edge systems can have the same or complementary capabilities, in various implementations. That is, each individual edge node does not have to implement the entire spectrum of capabilities. Instead, the edge capabilities may be distributed across multiple edge nodes and systems, which may collaborate to help each other to provide the desired services. In other words, an edge system can include any number of virtualized services and/or data stores that are spread across the distributed edge nodes. This may include a master-slave configuration, publish-subscribe configuration, or peer-to-peer configuration.

Low power and Lossy Networks (LLNs), e.g., certain sensor networks, may be used in a myriad of applications such as for “Smart Grid” and “Smart Cities.” A number of challenges in LLNs have been presented, such as:

1) Links are generally lossy, such that a Packet Delivery Rate/Ratio (PDR) can dramatically vary due to various sources of interferences, e.g., considerably affecting the bit error rate (BER);

2) Links are generally low bandwidth, such that control plane traffic must generally be bounded and negligible compared to the low rate data traffic;

3) There are a number of use cases that require specifying a set of link and node metrics, some of them being dynamic, thus requiring specific smoothing functions to avoid routing instability, considerably draining bandwidth and energy;

4) Constraint-routing may be required by some applications, e.g., to establish routing paths that will avoid non-encrypted links, nodes running low on energy, etc.;

5) Scale of the networks may become very large, e.g., on the order of several thousands to millions of nodes; and

6) Nodes may be constrained with a low memory, a reduced processing capability, a low power supply (e.g., battery).

In other words, LLNs are a class of network in which both the routers and their interconnect are constrained: LLN routers typically operate with constraints, e.g., processing power, memory, and/or energy (battery), and their interconnects are characterized by, illustratively, high loss rates, low data rates, and/or instability. LLNs are comprised of anything from a few dozen and up to thousands or even millions of LLN routers, and support point-to-point traffic (between devices inside the LLN), point-to-multipoint traffic (from a central control point to a subset of devices inside the LLN) and multipoint-to-point traffic (from devices inside the LLN towards a central control point).

An example implementation of LLNs is an “Internet of Things” network. Loosely, the term “Internet of Things” or “IoT” may be used by those in the art to refer to uniquely identifiable objects (things) and their virtual representations in a network-based architecture. In particular, the next frontier in the evolution of the Internet is the ability to connect more than just computers and communications devices, but rather the ability to connect “objects” in general, such as lights, appliances, vehicles, HVAC (heating, ventilating, and air-conditioning), windows and window shades and blinds, doors, locks, etc. The “Internet of Things” thus generally refers to the interconnection of objects (e.g., smart objects), such as sensors and actuators, over a computer network (e.g., IP), which may be the Public Internet or a private network. Such devices have been used in the industry for decades, usually in the form of non-IP or proprietary protocols that are connected to IP networks by way of protocol translation gateways. With the emergence of a myriad of applications, such as the smart grid advanced metering infrastructure (AMI), smart cities, and building and industrial automation, and cars (e.g., that can interconnect millions of objects for sensing things like power quality, tire pressure, and temperature and that can actuate engines and lights), it has been of the utmost importance to extend the IP protocol suite for these networks.

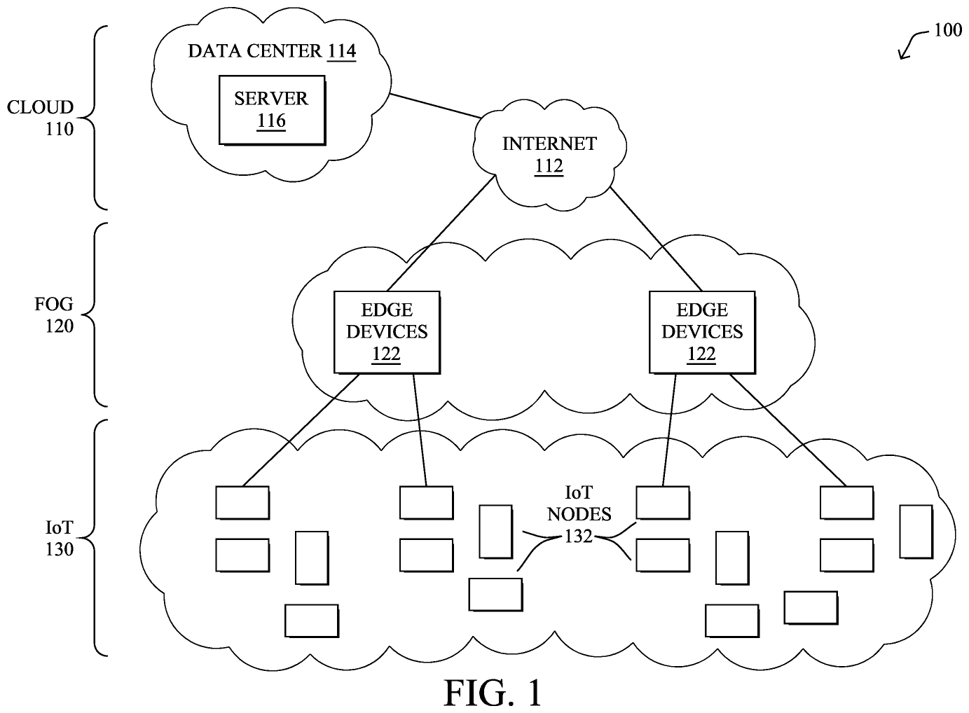

FIG. 1 is a schematic block diagram of an example simplified computer network 100 illustratively comprising nodes/devices at various levels of the network, interconnected by various methods of communication. For instance, the links may be wired links or shared media (e.g., wireless links, PLC links, etc.) where certain nodes, such as, e.g., routers, sensors, computers, etc., may be in communication with other devices, e.g., based on connectivity, distance, signal strength, current operational status, location, etc.

Specifically, as shown in the example IoT network 100, three illustrative layers are shown, namely cloud layer 110, edge layer 120, and IoT device layer 130. Illustratively, the cloud layer 110 may comprise general connectivity via the

Internet 112, and may contain one or more datacenters 114 with one or more centralized servers 116 or other devices, as will be appreciated by those skilled in the art. Within the edge layer 120, various edge devices 122 may perform various data processing functions locally, as opposed to datacenter/cloud-based servers or on the endpoint IoT nodes 132 themselves of IoT device layer 130. For example, edge devices 122 may include edge routers and/or other networking devices that provide connectivity between cloud layer 110 and IoT device layer 130. Data packets (e.g., traffic and/or messages sent between the devices/nodes) may be exchanged among the nodes/devices of the computer network 100 using predefined network communication protocols such as certain known wired protocols, wireless protocols, PLC protocols, or other shared-media protocols where appropriate. In this context, a protocol consists of a set of rules defining how the nodes interact with each other.

Those skilled in the art will understand that any number of nodes, devices, links, etc. may be used in the computer network, and that the view shown herein is for simplicity. Also, those skilled in the art will further understand that while the network is shown in a certain orientation, the network 100 is merely an example illustration that is not meant to limit the disclosure.

Data packets (e.g., traffic and/or messages) may be exchanged among the nodes/devices of the computer network 100 using predefined network communication protocols such as certain known wired protocols, wireless protocols (e.g., IEEE Std. 802.15.4, Wi-Fi, Bluetooth®, DECT-Ultra Low Energy, LoRa, etc..), PLC protocols, or other shared-media protocols where appropriate. In this context, a protocol consists of a set of rules defining how the nodes interact with each other.

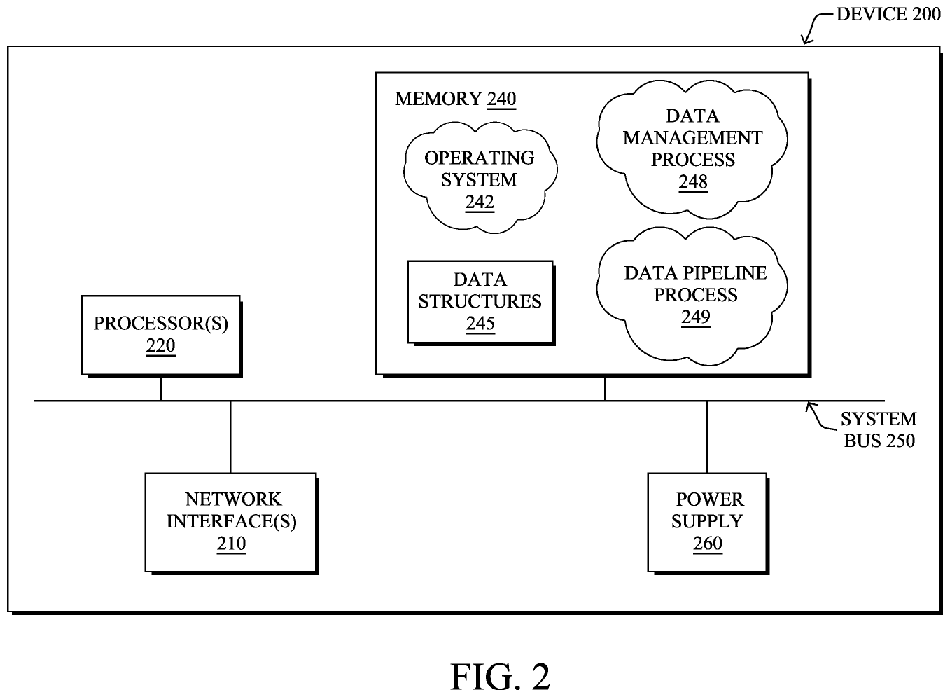

FIG. 2 is a schematic block diagram of an example node/device 200 that may be used with one or more embodiments described herein, e.g., as any of the nodes or devices shown in FIG. 1 above or described in further detail below. The device 200 may comprise one or more network interfaces 210 (e.g., wired, wireless, PLC, etc.), at least one processor 220, and a memory 240 interconnected by a system bus 250, as well as a power supply 260 (e.g., battery, plug-in, etc.).

Network interface(s) 210 include the mechanical, electrical, and signaling circuitry for communicating data over links coupled to the network. The network interfaces 210 may be configured to transmit and/or receive data using a variety of different communication protocols, such as TCP/IP, UDP, etc. Note that the device 200 may have multiple different types of network connections, e.g., wireless and wired/physical connections, and that the view herein is merely for illustration. Also, while the network interface 210 is shown separately from power supply 260, for PLC the network interface 210 may communicate through the power supply 260, or may be an integral component of the power supply. In some specific configurations the PLC signal may be coupled to the power line feeding into the power supply.

The memory 240 comprises a plurality of storage locations that are addressable by the processor 220 and the network interfaces 210 for storing software programs and data structures associated with the embodiments described herein. The processor 220 may comprise hardware elements or hardware logic adapted to execute the software programs and manipulate the data structures 245. An operating system 242, portions of which are typically resident in memory 240 and executed by the processor, functionally organizes the device by, among other things, invoking operations in support of software processes and/or services executing on the device. These software processes/services may comprise an illustrative data management process 248 and/or a data pipeline configuration process 249, as described herein.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while the processes have been shown separately, those skilled in the art will appreciate that processes may be routines or modules within other processes.

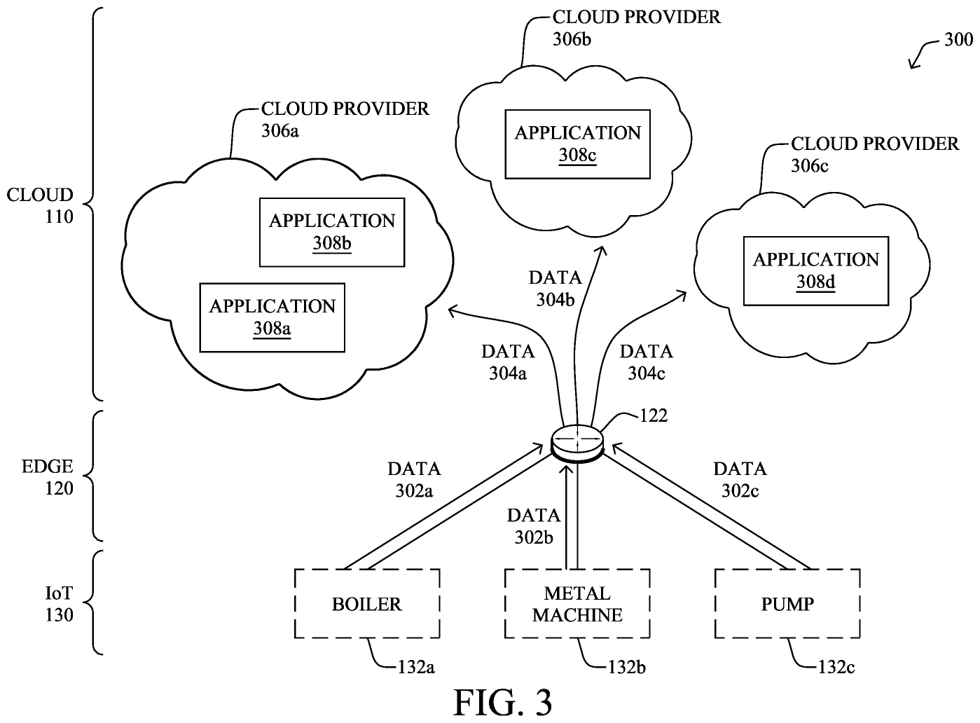

FIG. 3 illustrates an example network architecture 300 for edge to multi-cloud processing and governance, according to various embodiments. As shown, consider the case of an IoT network at IoT layer 130 that comprises a plurality of nodes 132, such as node 132a (e.g., a boiler), node 132b (e.g., a metal machine), and node 132c (e.g., a pump). Notably, the IoT network at IoT layer 130 may comprise any numbers of sensors and/or actuators. For instance, the network may be located in an industrial setting, such as a factory, port, substation, or the like, a smart city, a stadium, a conference or office building, or any other location in which IoT devices may be deployed.

As noted above, as the IoT evolves, the variety of IoT devices will continue to grow, as well as the number of applications associated with the IoT devices. As a result, multiple cloud-based applications may take as input measurements or other data. generated by a particular IoT device/node. For instance, as shown, assume that IoT nodes 132a-132c generate data 302a-302c, respectively, for consumption by any number of applications 308 hosted by different cloud providers 306, such as Microsoft Azure, Software AG, Quantela, MQTT/DC, or the like.

To complicate the collection and distribution of data 302a-302c, the different applications 308 may also require different sets of data 304a-304c from data 302a-302c. For instance, assume that cloud provider 306a hosts application 308a, which is a monitoring application used by the operator of the IoT network. In addition, cloud provider 306a may also host application 308b, which is a developer application that allows the operator of the IoT network to develop and deploy utilities and configurations for the IoT network. Another application, application 308c, may be hosted by an entirely different cloud provider 306b and be used by the vendor or manufacturer of a particular IoT node 132 for purposes. Finally, a further application, application 308d, may be hosted h a third cloud provider 306c, which is used by technicians for purposes of diagnostics and the like.

From the standpoint of the edge device 122, such as a router or gateway at the edge of the IoT network, the lack of harmonization between data consumers can lead to overly complicated data access policies, virtual models of IoT nodes 132 (e.g., ‘device twins’ or ‘device shadows’) that are often not portable across cloud providers 306, and increased resource consumption. In addition, different IoT nodes may communicate using different protocols within the IoT network. For instance, IoT nodes 132a-132c may communicate using MQTT, Modbus, OPC Unified Architecture (OPC UA), combinations thereof, or other existing communication protocols that are typically used in IoT networks. As a result, the various data pipelines must be configured on an individual basis at edge device 122 and for each of the different combinations of protocols and destination cloud providers 306.

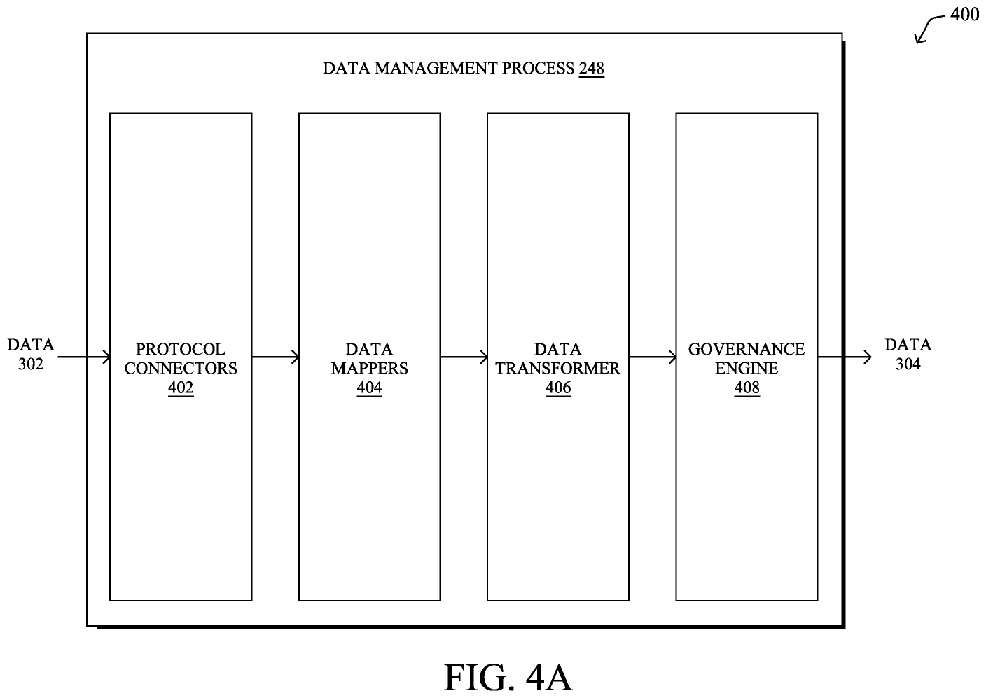

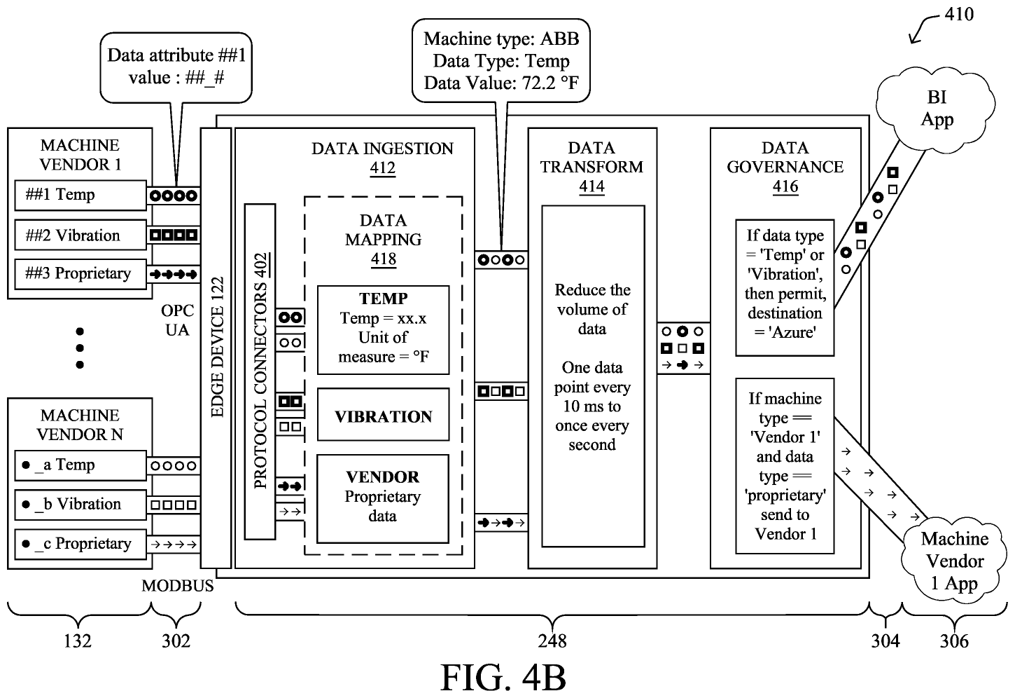

FIG. 4A illustrates an example architecture 400 for data management process 248, according to various embodiments. As shown, data management process 248 may comprise any or all of the following components: a plurality of protocol connectors 402, data mappers 404, a data transformer 406, and/or a governance engine 408. Typically, these components are executed on a single device located at the edge of the IoT network. However, further embodiments provide for these components to be executed in a distributed manner across multiple devices, in which case the combination of devices can be viewed as a singular device for purposes of the teachings herein. Further, functionalities of the components of architecture 400 may also be combined, omitted, or implemented as part of other processes, as desired.

During execution, protocol connectors 402 may comprise a plurality of southbound connectors that are able to extract data 302 from traffic in the IoT network sent via any number of different protocols. For instance, protocol connectors 402 may include connectors for OPC UA, Modbus, Ethernet/IP, MQTT, and the like. Accordingly, when the device executing data management process 248 (e.g., device 200) receives a message from the IoT network, such as a packet, frame, collection thereof, or the like, protocol connectors 402 may process the message using its corresponding connector to extract the corresponding data 302 from the message.

Once data management process 248 has extracted data 302 from a given message using the appropriate connector in protocol connectors 402, data mappers 404 may process the extracted data 302. More specifically, in various embodiments, data mappers 404 may normalize the extracted data 302. Typically, this may entail identifying the data extracted from the traffic in the network as being of a particular data type and grouping the data extracted from the traffic in the network with other data of the particular data type. In some instances, this may also entail associating a unit of measure with the extracted data 302 and/or converting a data value in one unit of measure to that of another.

In various embodiments, once data 302 has been extracted and normalized, data transformer 406 may apply any number of data transformation to the data. In some embodiments, data transformer 406 may transform data 302 by applying any number of mathematical and/or symbolic operations to it. For instance, data transformer 406 may apply a data compression or data reduction to the extracted and normalized data 302, so as to summarize or reduce the volume of data transmitted to the cloud. To do so, data transformer 406 may sample data 302 over time, compute statistics regarding data 302 (e.g., its mean, median, moving average, etc.), apply a compression algorithm to data 302, combinations thereof, or the like.

In further embodiments, data transformer 406 may apply analytics to the extracted and normalized data 302, so as to transform the data into a different representation, such as an alert or other indication. For instance, data transformer 406 may apply simple heuristics and/or thresholds to data 302, to transform data 302 into an alert. In another embodiment, data transformer 406 may apply machine learning to data 302, to transform the data.

In general, machine learning is concerned with the design and the development of techniques that take as input empirical data (such as network statistics and performance indicators), and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a,b,c such that the number of misclassified points is minimal. After this optimization phase (or learning phase), the model M can be used very easily to classify new data points. Often, M is a statistical model, and the cost function is inversely proportional to the likelihood of M, given the input data.

Data transformer 406 may employ one or more supervised, unsupervised, or semi-supervised machine learning models. Generally, supervised learning entails the use of a training set of data that is used to train the model to apply labels to the input data. For example, the training data may include samples of ‘good’ readings or operations and ‘bad’ readings or operations that are labeled as such. On the other end of the spectrum are unsupervised techniques that do not require a training set of labels. Notably, while a supervised learning model may look for previously seen patterns that have been labeled as such, an unsupervised model may instead look to whether there are sudden changes in the behavior. For instance, an unsupervised model may Semi-supervised learning models take a middle ground approach that uses a greatly reduced set of labeled training data.

Example machine learning techniques that data transformer 406 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), logistic or other regression, Markov models or chains, principal component analysis (PCA) (e.g., for linear models), singular value decomposition (SVD), multi-layer perceptron (MLP) ANNs (e.g., for non-linear models), replicating reservoir networks (e.g., for non-linear models, typically for time series), random forest classification, deep learning models, or the like.

In further embodiments, data transformer 406 may comprise a scripting engine that allows developers to deploy any number of scripts to be applied to data 302 for purposes of the functionalities described above. For instance, an application developer may interface with application 308b shown previously in FIG. 3, to develop and push various scripts for execution by data transformer 406, if allowed to do so by policy. In other cases, previously developed scripts may also be pre-loaded into data transformer 406 and/or made available by the vendor or manufacturer of the device executing data management process 248 for deployment to data transformer 406.

According to various embodiments, another potential component of data management process 248 is governance engine 408 that is responsible for sending the data 302 transformed by data transformer 406 to any number of cloud providers as data 304. In general, governance engine 408 may control the sending of data 304 according to a policy. For instance, governance engine 408 may apply a policy that specifies that data 304 may be sent to a particular cloud provider and/or cloud-based application, but should not be sent to others. In some embodiments, the policy enforced by governance engine 408 may control the sending of data 304 on a per-value or per-data type basis. For instance, consider the case of an IoT node reporting a temperature reading and pressure reading. In such a case, governance engine 408 may send the temperature reading to a particular cloud provider as data 304 while restricting the sending of the pressure reading, according to policy.

As would be appreciated, by unifying the policy enforcement via governance engine 408, the various stakeholders in the data pipelines are able to participate in the creation and maintenance of the enforced policies. Today, the various data pipelines built to support the different network protocols and cloud vendors results in a disparate patchwork of policies that require a level of expertise that not every participant may possess. In contrast, by unifying the policy enforcement via governance engine 408, personnel such as security experts, data compliance representatives, technicians, developers, and the like can participate in the administration of the policies enforced by governance engine 408.

FIG. 4B illustrates an example 410 of the operation of data management process 248 during execution, according to various embodiments. As shown, assume that edge device 122 described previously (e.g., a device 200) executes data management process 248 at the edge of an IoT network that comprises IoT nodes 132. During operation, edge device 122 may communicate with IoT nodes 132 in the network that comprise devices from n-number of different vendors.

Each set of vendor devices in IoT nodes 132 may generate different sets of data, such as sensor readings, computations, or the like. For instance, the devices from a first machine vendor may generate data such as a proprietary data value, a temperature reading, and a vibration reading. Similarly, the devices from another machine vendor may generate data such as a temperature reading, a vibration reading, and another data value that is proprietary to that vendor.

As would be appreciated, the data 302 generated from each group of IoT nodes 132 may use different formats that are set by the device vendors or manufacturers. For instance, two machines from different vendors may both report temperature readings, but using different data attribute labels (e.g., “temp=,” “temperature=,” “##1,” “*_a,” etc.). In addition, the actual data values may differ by vendor, as well. For instance, the different temperature readings may report different levels of precision/number of decimals, use different units of measure (e.g., Celsius, Fahrenheit, Kelvin, etc.), etc.

Another way in which data 302 generated by IoT nodes 132 may differ is the network protocol used to convey data 302 in the network. For instance, the devices from one machine vendor may communicate using the OPC UA protocol, while the devices from another machine vendor may communicate using the Modbus protocol.

In response to receiving data 302 from IoT nodes 132, data management process 248 of edge device 122 may process data 302 in three stages: a data ingestion phase 412, a data transformation phase 414, and a data governance phase 416. These three processing phases operate in conjunction with one another to allow edge device 122 to provide data 304 to the various cloud providers 306 for consumption by their respective cloud-hosted applications.

During the data ingestion phase 412, protocol connectors 402 may receive messages sent by IoT nodes 132 in their respective protocols, parse the messages, and extract the relevant data 302 from the messages. For instance, one protocol connector may process OPC UA messages sent by one set of IoT nodes 132, while another protocol connector may process Modbus messages sent by another set of IoT nodes 132. Once protocol connectors 402 have extracted the relevant data 302 from the messages, data management process 248 may apply a data mapping 418 to the extracted data, to normalize the data 302. For instance, data management process 248 may identify the various types of reported data 302 and group them by type, such as temperature measurements, vibration measurements, and vendor proprietary data. In addition, the data mapping 418 may also entail standardizing the data on a particular format (e.g., a particular number of digits, unit of measure, etc.). The data mapping 418 may also entail associating metadata with the extracted data 302, such as the source device type, its vendor, etc.

During its data transformation phase 414, data management process 248 may apply various transformations to the results of the data ingestion phase 412. For instance, assume that one IoT node 132 reports its temperature reading every 10 milliseconds (ms). While this may be acceptable in the IoT network, and even required in some cases, reporting the temperature readings at this frequency to the cloud-providers may represent an unnecessary load on the WAN connection between edge device 122 and the cloud provider(s) 306 to which the measurements are to be reported. Indeed, a monitoring application in the cloud may only need the temperature readings at a frequency of once every second, meaning that the traffic overhead to the cloud provider(s) 306 can be reduced by a factor of one hundred by simply reporting the measurements at one second intervals. Accordingly, data transformation phase 414 may reduce the volume of data 304 sent to cloud provider(s) 306 by sending only a sampling of the temperature readings (e.g., every hundred), an average or other statistic(s) of the temperature readings in a given time frame, or the like.

During its data governance phase 416, data management process 248 may apply any number of different policies to the transformed data, to control how the resulting data 304 is sent to cloud provider(s) 306. For instance, one policy enforced during data governance phase 416 may specify that if the data type=‘Temp’ or ‘Vibration,’ then that data is permitted to be sent to destination=‘Azure,’ for consumption by a BI application hosted by Microsoft Azure. Similarly, another policy may specify that if the machine type=‘Vendor 1’ and the data type=‘proprietary,’ then the corresponding data can be sent to a cloud provider associated with the vendor.

In some embodiments, the policy enforced during data governance phase 416 may further specify how data 304 is sent to cloud providers 306. For instance, the policy may specify that edge device 122 should send data 304 to a particular cloud provider 306 via an encrypted tunnel, using a particular set of one or more protocols (e.g., MQTT), how the connection should be monitored and reported, combinations thereof, and the like.

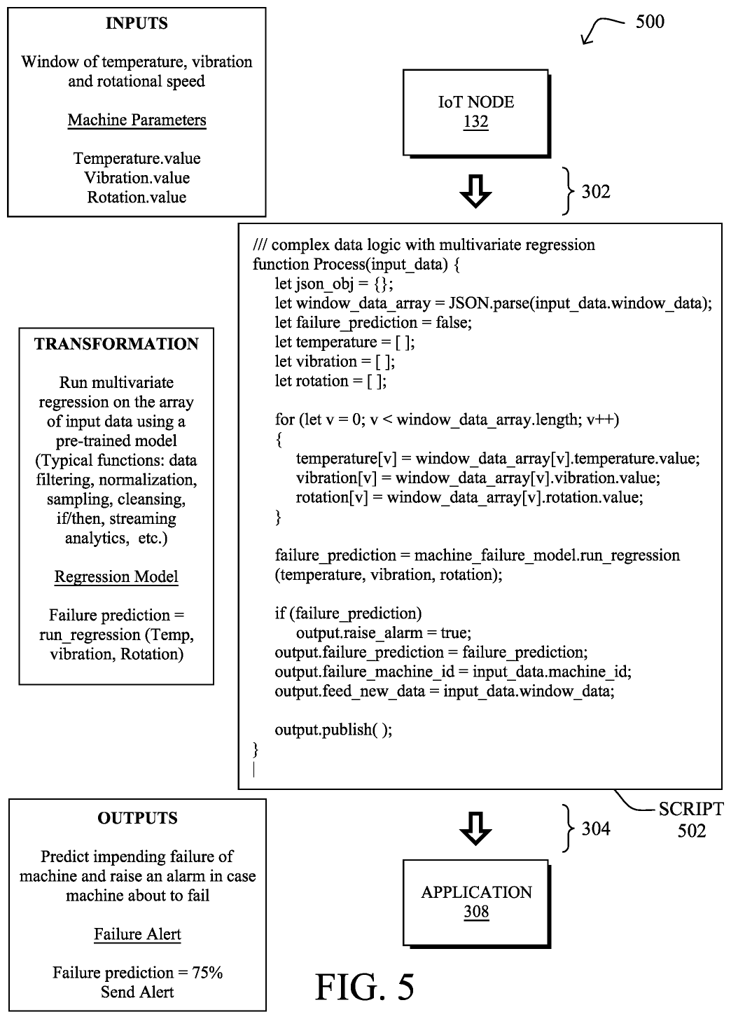

FIG. 5 illustrates an example 500 of the application of a script to data extracted from traffic in a network, according to various embodiments. As noted previously with respect to FIG. 4A, some embodiments of data transformer 406 provide for data transformer 406 to comprise a scripting engine, allowing for customization of the data transformations applied to the data from the IoT nodes 132. For instance, as shown, assume that IoT node 132 generates machine parameters, such as ‘temperature.value,’ ‘vibration.value,’ and ‘rotation.value,’ and sends these parameters to the edge device as data 302.

During its data transformation phase, the edge device may execute a script 502 that takes as input the data 302 provided by IoT node 132, potentially after normalization. In turn, script 502 may perform multivariate regression on the array of input data using a pre-trained machine learning model. Doing so allows script 502 to predict whether IoT node 132 is likely to fail, given its reported temperature, vibration, and rotation measurements. Depending on the results of this prediction, such as when the probability of failure is greater than a defined threshold (e.g., >75%), script 502 may output a failure alert that identifies IoT node 132, the probability of failure, or other information that may be useful to a technician or other user.

In cases in which script 502 generates an alert, the edge device may provide the alert as data 304 to one or more cloud providers for consumption by a cloud-hosted application, such as application 308, in accordance with its data governance policy. Since the input data from IoT node 132 has been extracted to be protocol-independent and normalized, this allows script 502 to predict failures across machines from different vendors. In addition, as the alerting is handled directly on the edge device, this can greatly reduce overhead on its WAN connection, as the edge device may only be required to report alerts under certain circumstances (e.g., when the failure probability is greater than a threshold), rather than reporting the measurements themselves for the analysis to be performed in the cloud.

As noted above, edge devices are increasingly sending data from IoT endpoints to multiple cloud providers for consumption by various applications. Indeed, both the manufacturers of many IoT nodes and the operators of those nodes may need access to the data being generated by the IoT nodes. For instance, the manufacturer of an IoT node may monitor its nodes to gain performance insights and perform preventative maintenance. Conversely, the operator of the IoT node, such as the owner of a factory, may collect real-time telemetry data from the device to ensure that their business is running, optimally.

However, there are almost limitless types of IoT nodes, each node supporting different data models that define how the data is processed at the edge (e.g., ingested, transformed, etc.). Additionally, there is a plethora of different cloud analytics services to which the data may need to be sent. Further, the various IoT nodes may generate data differently, meaning that a new data model and data pipeline may need to be defined, potentially on a per-node basis, creating a great amount of overhead on the operator and solutions integrator.

Automatic Orchestration of IoT Device Data Management Pipeline Operations

The techniques introduced herein allow the automatic configuration of data models and data management pipelines at the edge of a network, when a new endpoint node joins the network. In some aspects, this may entail configuring an edge device to extract, map, transform, and/or send data generated by the endpoint node for consumption by any number of applications hosted across various cloud providers.

Illustratively, the techniques described herein may be performed by hardware, software, and/or firmware, such as in accordance with data management process 248 and/or data pipeline configuration process 249, which may include computer executable instructions executed by the processor 220 (or independent processor of interfaces 210) to perform functions relating to the techniques described herein.

Specifically, a supervisory device that supervises an edge device at an edge of a network receives a uniform resource identifier specified by a node in the network. The supervisory device retrieves information regarding the node located at the uniform resource identifier. The supervisory device generates, based on the information regarding the node, a data pipeline configuration for the edge device. The supervisory device sends the data pipeline configuration to the edge device. The data pipeline configuration causes the edge device to extract data from traffic sent by the node in the network and specifies one or more cloud-hosted applications to which the data should be sent

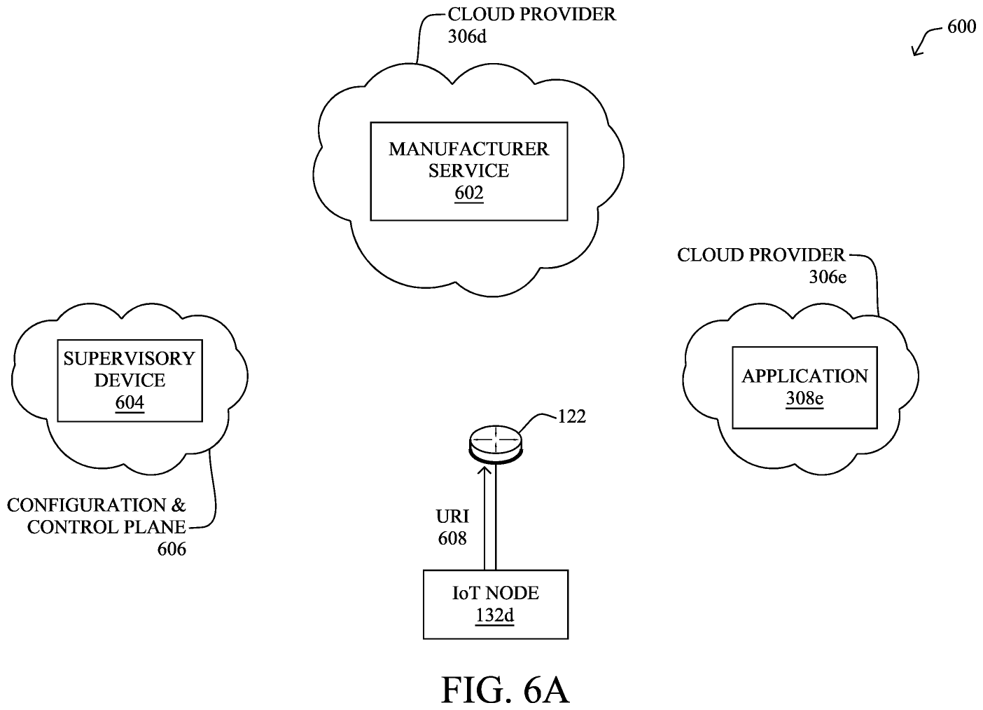

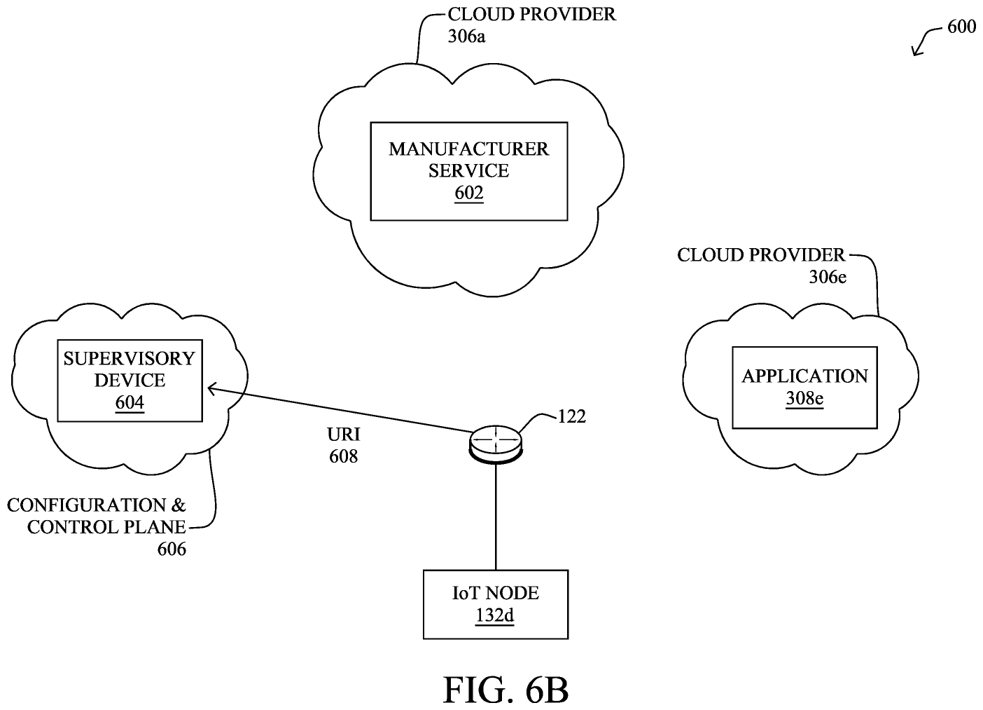

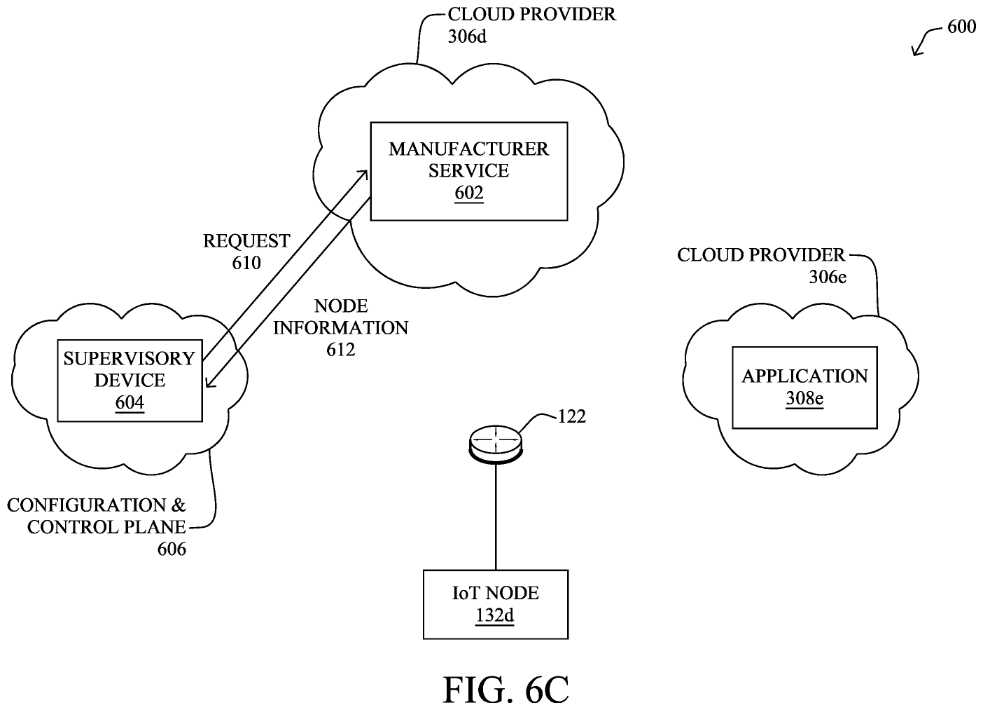

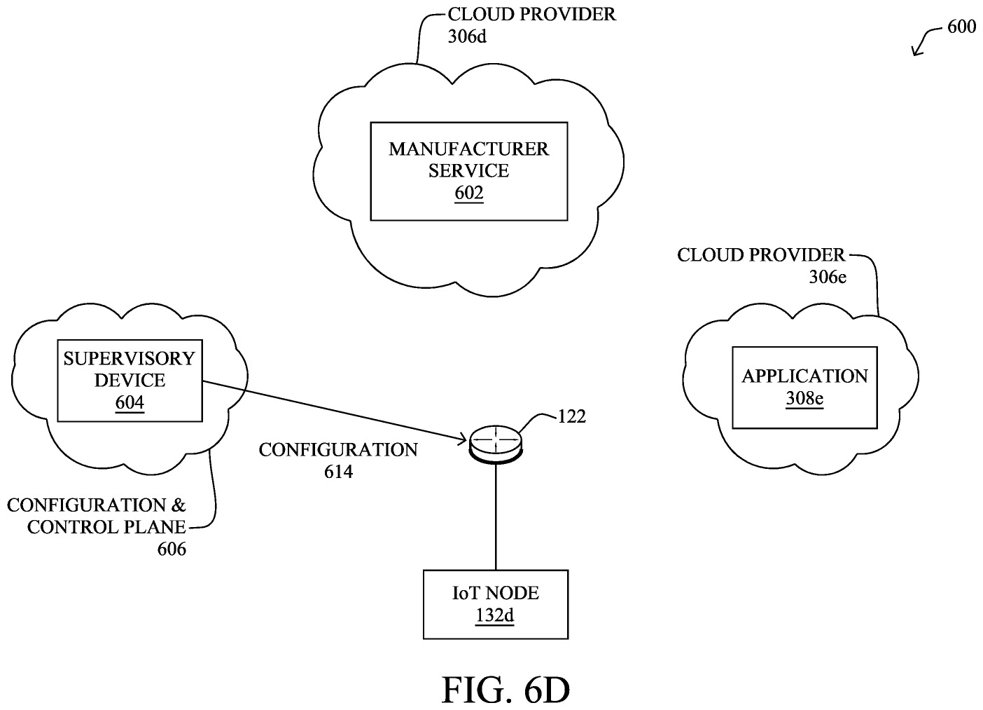

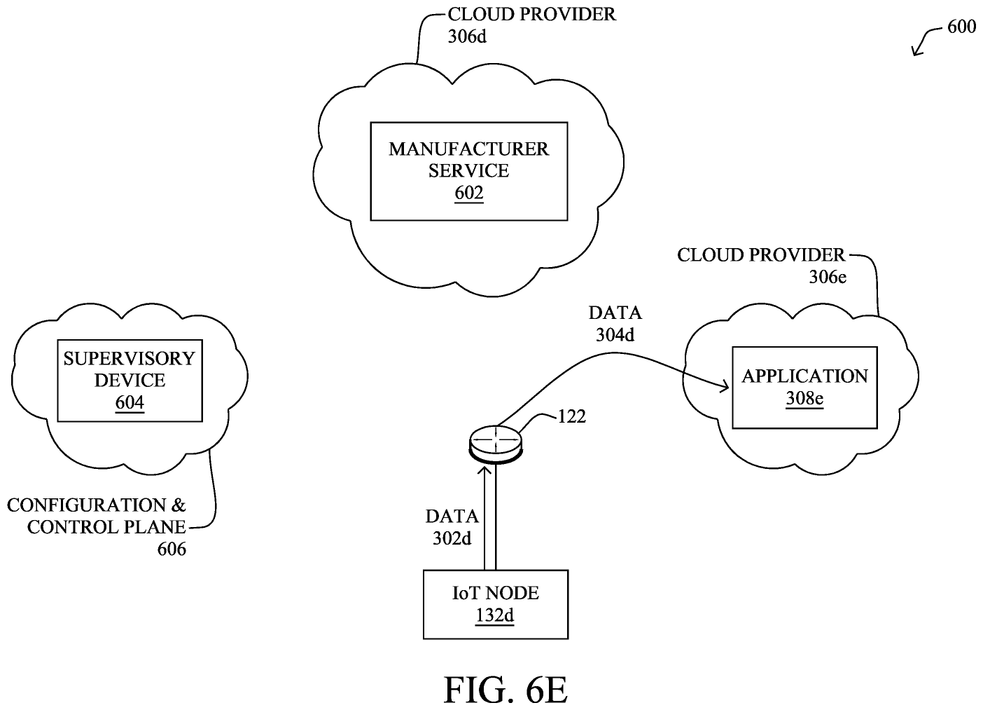

Operationally, FIGS. 6A-6E illustrates an example 600 of the automatic orchestration of device data management pipeline operations, according to various embodiments. Continuing the previous examples, assume that there is an edge device 122 located at the edge of a network to which a new IoT node 132d joins (e.g., a new sensor, actuator, etc.). Further, assume that there is a supervisory device 604 that is part of a configuration and control plane 606 and provides supervisory control over edge device 122, once edge device 122 is enrolled with supervisory device 604. For instance, supervisory device 604 may take the form of a server that serves Edge Intelligence Control Service by Cisco Systems, Inc., or another device that provides a supervisory service to edge device 122. Note that while supervisory device 604 is typically located external to the network in which IoT node 132d is located, further embodiments provide for supervisory device 604 to be located within that network, as well.

In the cloud, assume that there is an application 308e hosted by cloud provider 306e that is to consume data generated by IoT node 132d. For instance, application 308e may be a monitoring application used by the operator of the network to which IoT node 132d was added to monitor an industrial process, the manufacturer of IoT node 132d for purposes of performing diagnostics or updates, etc.

As shown, there may also be a manufacturer service 602 hosted by cloud provider 306d that is in charge of aiding supervisory device 604 in the configuration of the data pipeline between IoT node 132d and application 308e. As would be appreciate, while application 308e and manufacturer service 602 are shown in FIG. 6A as being hosted by separate cloud providers, cloud provider 306d and cloud provider 306e, respectively, further embodiments provide for them to be hosted by the same cloud provider. Further, while a single application 308e is shown in FIG. 6A for purposes of consuming data generated by IoT node 132d, the techniques herein can be used to configure data pipelines to any number of applications 308, in a similar manner.

In various embodiments, IoT node 132d may be configured to send a universal resource identifier (URI) 608 that points to manufacturer service 602. For instance, in one embodiment, IoT node 132d may send URI 608 as part of a Manufacturer Usage Description (MUD) message, in accordance with the Manufacturer Usage Description Specification by E. Lear et al. from the Internet Engineering Task Force (IETF). Typically, IoT node 132d may send URI 608 when it first joins the network, during an onboarding process. However, IoT node 132d may send URI 608 at other times, such as in response to a request to do so. In one embodiment, for instance, edge device 122 may discover and access URI 608 by probing IoT node 132d on a known port. In general, URI 608 points to a location hosted by manufacturer service 602 or another host at which information regarding IoT node 132d is located.

As shown in FIG. 6B, edge device 122 may receive URI 608 and forward it to supervisory device 604, in one embodiment. Then, as shown in FIG. 6C, supervisory device 604 may send a request 610 to manufacturer service 602 for information regarding IoT node 132d, using URI 608. For instance, URI 608 may be of the following form and used for request 610:

http(s)://<vendor-domain>.com/devicetype/protocol/protocol-version/deviceID.j son

Typically, supervisory device 604 and manufacturer service 602 may have an existing trust relationship, prior to supervisory device 604 sending request 610. For instance, supervisory device 604 and manufacturer service 602 may leverage a public-key infrastructure (PKI) or other security mechanism to ensure that both can confirm the identity of the other. In another instance, this trust relationship may entail supervisory device 604 maintaining a list of trusted manufacturers and their corresponding services. This ensures that a malicious node cannot be added to the network and trigger the installation of a data pipeline using the techniques herein, simply by pointing a URI to a malicious location.

In response to request 610, manufacturer service 602 may return node information 612 to supervisory device regarding IoT node 132d. In various embodiments, node io information 612 may indicate any or all of the following:
Protocol(s) used by IoT node 132d—this information allows supervisory device 604 to configure edge device 122 to extract data generated by IoT node 132d using appropriate protocol connector(s). For instance, if a new protocol connector is needed, node information 612 may signal to supervisory device 604 to install the appropriate protocol connector to IoT node 132d.
Data type(s) used by IoT node 132d—this information may indicate the data structure(s), formats (e.g., ASCII, text, string, integer, float, etc.), units of measure (e.g., Celsius, Fahrenheit, etc.), number of decimal points, and the like, that are used by IoT node 132d to convey its generated data.
Label(s) for data generated by IoT node 132d—this information may provide additional labels for the data generated by IoT node 132d. For instance, say that IoT node 132d generates and sends three distinct values per message: a temperature reading, a vibration reading, and a proprietary value. However, to reduce the size of the message, IoT node 132d may not include labels, or full labels, in the messages themselves. By including the labels in node information 612, this allows edge device 122 to apply labels to any of these extracted values.
Application(s) 308—node information 612 may also indicate one or more cloud-hosted applications to which data generated by IoT node 132d should be sent. Node information 612 may also, in some cases, indicate which values should be sent to a particular application 308. For instance, application 308e may not require the specific sensor measurements from IoT node 132d, but only proprietary health status data.
Data Transformation(s)—node information 612 may further indicate any data transformations that edge device 122 should apply to data generated by IoT node 132d. For instance, node information 612 may specify a frequency/rate at which certain data generated by IoT node 132d should be sent to application 308e, thereby indicating that an aggregation transformation should be applied in cases in which IoT node 132d sends the data at a higher rate (e.g., by reporting an average of values to application 308e during a certain time period, etc.).
Etc.

As would be appreciated, further embodiments provide for supervisory device 604 configuring edge device 122 to send request 610 directly. In turn, edge device 122 may receive node information 612 and forward this information to supervisory device 604 for further processing. Since the requesting by edge device 122 is still performed under the direction of supervisory device 604, this can still be viewed as ultimately being performed by supervisory device 604, albeit in an indirect manner.

In FIG. 6D, supervisory device 604 may send generate and send configuration 614 to edge device 122, based on node information 612, to establish one or more data pipelines for the data generated by IoT node 132d, in various embodiments. Generally speaking, configuration 614 includes parameters and/or instructions that cause edge device 122 to perform its data extraction, mapping, transformation, and/or policy governance functions with respect to the data generated by IoT node 132d .

In some embodiments, supervisory device 604 may also add any operator-specific configurations to configuration 614. For instance, say that the operator of network in which IoT node 132d is located wishes to apply one or more anomaly detectors to the data generated by IoT node 132d, even though such data transformations are not explicitly specified in node information 612. In such a case, supervisory device 604 may include an instruction in configuration 614 to apply these anomaly detector(s) to the data generated by IoT node 132d.

In FIG. 6E, after being configured via configuration 614, edge device 122 may extract data 302d generated and sent by IoT node 132d, process data 302d, and send data 304d onward for consumption by application 308e. For instance, assume that application 308e is an MQTT message broker and that data 302d includes a temperature measurement. In such a case, configuration 614 may specify the protocol connector(s) that edge node 122 should use to extract the temperature measurement, a label to be applied to the measurement, a unit of measure for the temperature measurement, a protocol via which data 304d should be sent (e.g., MQTT), an MQTT topic to which the measurement should be published, and the like.

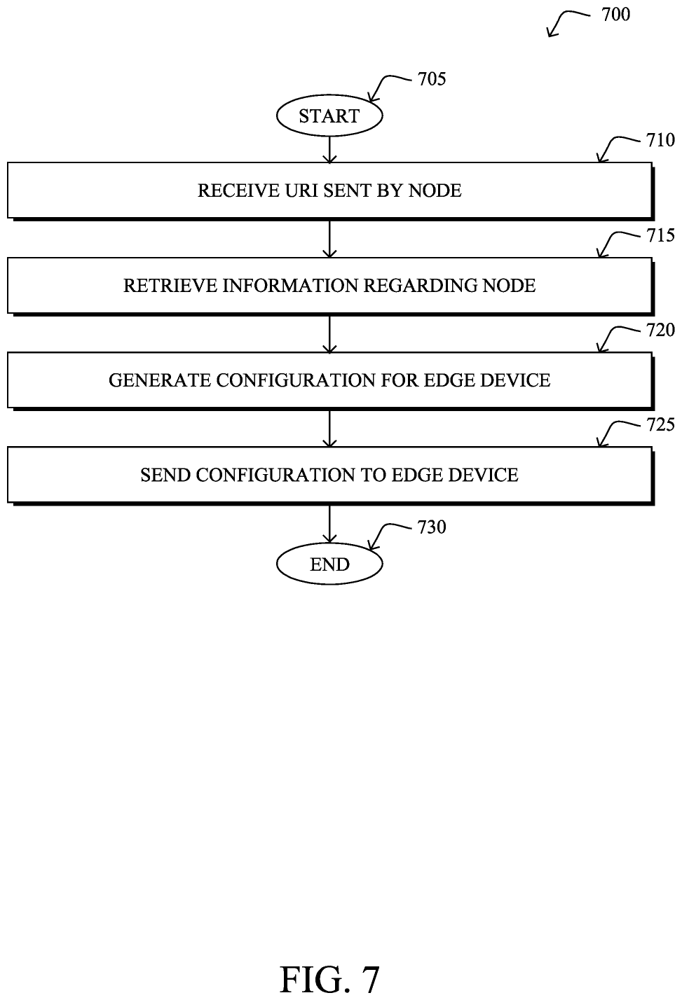

FIG. 7 illustrates an example simplified procedure for the configuration of a data management pipeline for an edge device, in accordance with one or more embodiments described herein. The procedure 700 may start at step 705, and continues to step 710, where, as described in greater detail above, a specifically configured supervisory device (e.g., device 200) that supervises an edge device an edge of a network, receives a uniform resource identifier (URI) specified by a node in the network. In some embodiments, the node may specify the URI via a Manufacturer Usage Description (MUD) message sent by the node. The edge device may, for instance, comprise a network router, network gateway, network access point, or other networking device that captures and sends the URI to the supervisory device.

At step 715, as detailed above, the supervisory device may retrieve information regarding the node located at the URI. In various embodiments, the information regarding the node may specify a protocol used by traffic sent by the node, a data model for the node (e.g., data labels that should be applied to data generated by the node, a data transformation to be applied to the data, etc.), one or more cloud-hosted applications to which the data generated by the node should be sent, or the like. For instance, in the case of a temperature sensor, the retrieved information may indicate that the temperature sensor sends its readings via Modbus, the readings are in Fahrenheit, and that aggregated measurements should be sent to a monitoring service associated with the manufacturer of the sensor.

At step 720, the supervisory device may generate, based on the information regarding the node, a data pipeline configuration for the edge device, as described in greater detail above. In one embodiment, the configuration may specify that the edge device should extract data generated by the node from traffic sent by the node using a particular protocol connector. In various embodiments, the configuration may specify any data labels, mappings, and/or transformations that the edge device should apply to the data from the node. For instance, the configuration may comprise a data transformation script for execution by the edge device on the data extracted by the edge device. In a further embodiment, the configuration may specify one or more cloud-hosted application to which the edge device should send the data generated by the node and/or any specific formats, protocols, or credentials needed to do so. For instance, one of the cloud-hosted applications may comprise an MQTT message broker and the configuration may indicate an MQTT topic to which the data should be published by the edge device.

At step 725, as detailed above, the supervisory device sends the data pipeline configuration to the edge device. In turn, the data pipeline configuration causes the edge device to extract data from traffic sent by the node in the network and specifies one or more cloud-hosted applications to which the data should be sent. For instance, such an application may be associated with a manufacturer of the node, thereby allowing certain information to be sent from the node back to the manufacturer (e.g., for purposes of diagnostics, etc.). In further embodiments, the configuration may specify the data format(s) to be used by the sent data (e.g., temperature readings should be in Celsius, labeled as ‘temperature,’ etc.), which extracted data should be sent (e.g., only proprietary data and not sensor readings, etc.), a frequency at which the extracted data should be sent, a data transformation to be applied to the extracted data before sending (e.g., a script for execution by the edge device on the extracted data, etc.), security credentials or other information for the application(s), an indication of which protocol connector(s) should be used to extract the data, combinations thereof, or the like.

At step 730, the supervisory device may send the data pipeline configuration to the edge device, as described in greater detail above. In various embodiments, the data pipeline configuration causes the edge device to extract data from traffic sent by the node in the network and specifies one or more cloud-hosted applications to which the data should be sent. By pushing such a configuration to the edge device, the system can effectively establish a data pipeline between the new node in the network and one or more cloud-hosted application(s) that consume data generated by the node. Procedure 700 then ends at step 735.

It should be noted that while certain steps within procedure 700 may be optional as described above, the steps shown in FIG. 7 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

The techniques described herein, therefore, provide an automated mechanism for the onboarding of a new IoT node to a network and the establishment of a data pipeline at the edge of the network for its data. This avoids complicated configuration schemes that require coordination between multiple parties, such as solution integrators, network operators, and the like.

While there have been shown and described illustrative embodiments for automatic orchestration of IoT device data management pipeline operations, it is to be understood that various other adaptations and modifications may be made within the intent and scope of the embodiments herein. For example, while specific protocols are used herein for illustrative purposes, other protocols and protocol connectors could be used with the techniques herein, as desired. Further, while the techniques herein are described as being performed by certain locations within a network, the techniques herein could also be performed at other locations, such as at one or more locations fully within the local network, etc.).

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true intent and scope of the embodiments herein.

1. A method comprising:
receiving, at a supervisory device that supervises an edge device at an edge of a network, a uniform resource identifier specified by a node in the network;
retrieving, by the supervisory device, information regarding the node from a location indicated by the uniform resource identifier;
generating, by the supervisory device and based on the information regarding the node, a data pipeline configuration for the edge device; and
sending, by the supervisory device, the data pipeline configuration to the edge device, wherein the data pipeline configuration causes the edge device to extract data from traffic sent by the node in the network and specifies one or more cloud-hosted applications to which the data should be sent.

2. The method as in claim 1, wherein the information regarding the node specifies a protocol used by the traffic sent by the node from which the edge device extracts the data.

3. The method as in claim 1, wherein the edge device comprises one of: a network router, a network gateway, or a network access point.

4. The method as in claim 1, wherein the information regarding the node specifies the one or more cloud-hosted applications to which the data extracted by the edge device should be sent.

5. The method as in claim 1, wherein the information regarding the node specifies a data transformation for the data, and wherein the data pipeline configuration comprises a script for execution by the edge device on the data extracted by the edge device to perform the data transformation.

6. The method as in claim 1, wherein the one or more cloud-hosted applications comprise an MQTT message broker, and wherein the information regarding the node specifies an MQTT topic to which the data should be published by the edge device.

7. The method as in claim 1, wherein the one or more cloud-hosted applications are associated with a manufacturer of the node in the network.

8. The method as in claim 1, further comprising:
establishing a trust relationship between the supervisory device and a host of the uniform resource identifier, prior to retrieving the information regarding the node located at the uniform resource identifier.

9. The method as in claim 1, wherein the node in the network specifies the uniform resource identifier via a Manufacturer Usage Description message sent by the node.

10. An apparatus, comprising:
one or more network interfaces;
a processor coupled to the one or more network interfaces and configured to execute one or more processes; and
a memory configured to store a process that is executable by the processor, the process when executed configured to:
receive, from an edge device at an edge of a network, a uniform resource identifier specified by a node in the network;
retrieve information regarding the node from a location indicated by the uniform resource identifier;
generate, based on the information regarding the node, a data pipeline configuration for the edge device; and
send the data pipeline configuration to the edge device, wherein the data pipeline configuration causes the edge device to extract data from traffic sent by the node in the network and specifies one or more cloud-hosted applications to which the data should be sent.

11. The apparatus as in claim 10, wherein the information regarding the node specifies a protocol used by the traffic sent by the node from which the edge device extracts the data.

12. The apparatus as in claim 11, wherein the edge device comprises one of: a network router, a network gateway, or a network access point.

13. The apparatus as in claim 10, wherein the information regarding the node specifies the one or more cloud-hosted applications to which the data extracted by the edge device should be sent.

14. The apparatus as in claim 10, wherein the information regarding the node specifies a data transformation for the data, and wherein the data pipeline configuration comprises a script for execution by the edge device on the data extracted by the edge device to perform the data transformation.

15. The apparatus as in claim 10, wherein the one or more cloud-hosted applications comprise an MQTT message broker, and wherein the information regarding the node specifies an MQTT topic to which the data should be published by the edge device.

16. The apparatus as in claim 10, wherein the one or more cloud-hosted applications are associated with a manufacturer of the node in the network.

17. The apparatus as in claim 10, wherein the process when executed is further configured to:
establish a trust relationship between the apparatus and a host of the uniform resource identifier, prior to retrieving the information regarding the node located at the uniform resource identifier.

18. The apparatus as in claim 10, wherein the node in the network specifies the uniform resource identifier via a Manufacturer Usage Description message sent by the node.

19. The apparatus as in claim 10, wherein the apparatus is located outside of the network.

20. A tangible, non-transitory, computer-readable medium storing program instructions that cause a supervisory device that supervises an edge device at an edge of a network, to execute a process comprising:
receiving, at the supervisory device, a uniform resource identifier specified by a node in the network;
retrieving, by the supervisory device, information regarding the node from a location indicated by the uniform resource identifier;
generating, by the supervisory device and based on the information regarding the node, a data pipeline configuration for the edge device; and
sending, by the supervisory device, the data pipeline configuration to the edge device, wherein the data pipeline configuration causes the edge device to extract data from traffic sent by the node in the network and specifies one or more cloud-hosted applications to which the data should be sent.
